(19) United States
(12) Patent Application Publication
(10) Pub. No.: US 2012/0310690 A1
(43) Pub. Date: Dec. 6, 2012

(54) ERP TRANSACTION RECORDING TO TABLES SYSTEM AND METHOD

(75) Inventors: Gurpreet Singh SIDHU, Chandigarh (IN); Munish GARG, Chandigarh (IN); Vishal CHALANA, Panchkula (IN)

(73) Assignee: WINSHUTTLE, LLC, Bothell, WA (US)

(21) Appl. No.: 13/464,707

(22) Filed: May 4, 2012

Related U.S. Application Data
(60) Provisional application No. 61/493,882, filed on Jun. 6, 2011.

(51) Int. Cl. G06Q 10/06

(52) U.S. Cl. 705/7.12

(57) ABSTRACT

An ERP client may automatically determine a list of one or more ERP database tables that store the data associated with a particular business transaction in the ERP system. At the time a given business transaction is executed via a business transaction UI, various embodiments record screen fields presented via the business transaction UI, map the screen fields to persistent ERP database fields, and report to the business user a list of database tables that the business transaction updated. The business user may then use this information to construct reports related to the business transaction or for other purposes.

### CROSS REFERENCE TO RELATED APPLICATIONS

This application claims the benefit of priority to U.S. Provisional Application No. 61/493,882, filed Jun. 6, 2011, titled “ERP TRANSACTION RECORDING TO TABLES SYSTEM AND METHOD”, filed under Attorney Docket No. WINS-2011021, and naming inventors Gurpreet Singh Sindhu, Munish Garg, and Vishal Sharma. The above-cited application is incorporated herein by reference in its entirety, for all purposes.

### FIELD

The present invention relates to databases, and more particularly to methods of identifying database tables updated by a business transaction.

### BACKGROUND

Enterprise resource planning (“ERP”) systems, such as SAP ERP Central Component (“ECC”) provided by SAP AG of Weinheim, Germany, are designed to coordinate some or all of the resources, information, and activities needed to complete business processes. An ERP system may support business functions including some or all of manufacturing, supply chain management, financials, projects, human resources, customer relationship management, and the like.

Many ERP systems incorporate a centralized database or other ERP data store, and many ERP vendors provide one or more reporting tools that can be used to access the ERP data store. However, it can be difficult and expensive to use vendor-provided reporting tools. Consequently, many businesses must maintain an expensive information technology (“IT”) to facilitate custom report creation. In many cases, creating a custom report may cost thousands of dollars to an enterprise running an ERP system.

One factor that makes it harder for business users to create their own reports is the sheer scale of the databases managed by the ERP system. For example, ECC version 6.0 uses approximately 70,000 database tables. Business users, including business users with little or no programming skill, use business transaction user interface (“UI”) screens to query and extract information from one or more transaction-related database tables of an ERP system. For many business transactions (e.g., Purchase order creation, sales order creation, and the like), multiple database tables may be referenced and/or updated in the course of performing the business transaction. However, using existing tools, it can be difficult and cumbersome for a typical business user to manually identify such database tables for a given business transaction.

### BRIEF DESCRIPTION OF THE DRAWINGS

FIG. 1 illustrates an exemplary ERP system in accordance with one embodiment.

FIG. 2 illustrates several components of an exemplary ERP client device in accordance with one embodiment.

FIG. 3 illustrates a conceptual overview of various data relationships in accordance with one embodiment.

FIG. 4 illustrates a routine for mapping screen UI fields associated with a business transaction to respectively corresponding ERP database tables, in accordance with one embodiment.

FIG. 5 illustrates a subroutine for automatically identifying a list of persistent database tables that correspond to a given list of one or more screen UI fields that are involved in a business transaction, in accordance with one embodiment.

FIG. 6 illustrates a subroutine for attempting to automatically identify a source database table for a given screen UI field, in accordance with one embodiment.

FIG. 7 illustrates a subroutine for updating unmapped screen UI fields according to an exhaustive scan of tables updated by programs associated with a business transaction, in accordance with one embodiment.

FIG. 8 illustrates a subroutine for determines whether a given table includes a field that is a likely match for a given screen UI field, in accordance with one embodiment.

FIGS. 9-16 depict various exemplary user interfaces illustrating various fields, tables, structures, characteristics, data objects, and/or concepts described herein.

### DESCRIPTION

According to various embodiments, as described below, an ERP client may automatically determine a list of one or more ERP database tables that store the data associated with a particular business transaction in the ERP system. At the time a given business transaction is executed via a business transaction UI, various embodiments record screen fields presented via the business transaction UI, maps the screen fields to persistent ERP database fields, and report to the business user a list of database tables that the business transaction updated. The business user may then use this information to construct reports related to the business transaction or for other purposes.

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers, and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

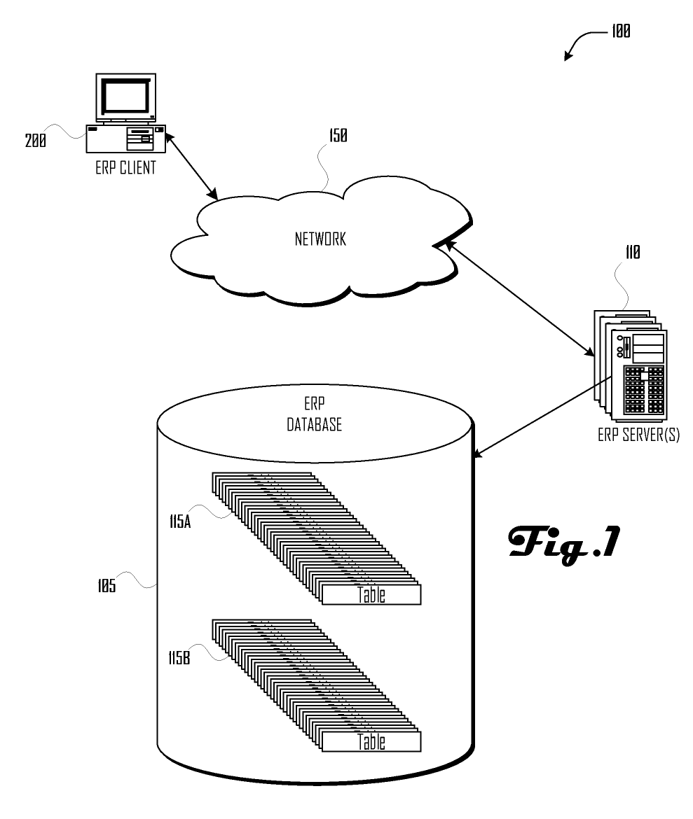

FIG. 1 illustrates an exemplary ERP system 100 in which an ERP client device 200 and one or more ERP Server(s) 110 are connected to a network 150. ERP Server(s) 110 is also in communication with an ERP database 105, which includes a multiplicity of persistent database tables 115A-B. In some embodiments, a multiplicity of persistent database tables may comprise 100 or more persistent database tables. In other embodiments, multiplicity of persistent database tables may comprise 1000 or more, or 10000 or more persistent database tables.

In some embodiments, ERP Server 110 may further comprise an application server (not shown), and/or ERP Server 110 may further include the functionality of an application server.

In various embodiments, network 150 may include the Internet, a local area network (“LAN”), a wide area network (“WAN”), and/or other data network.

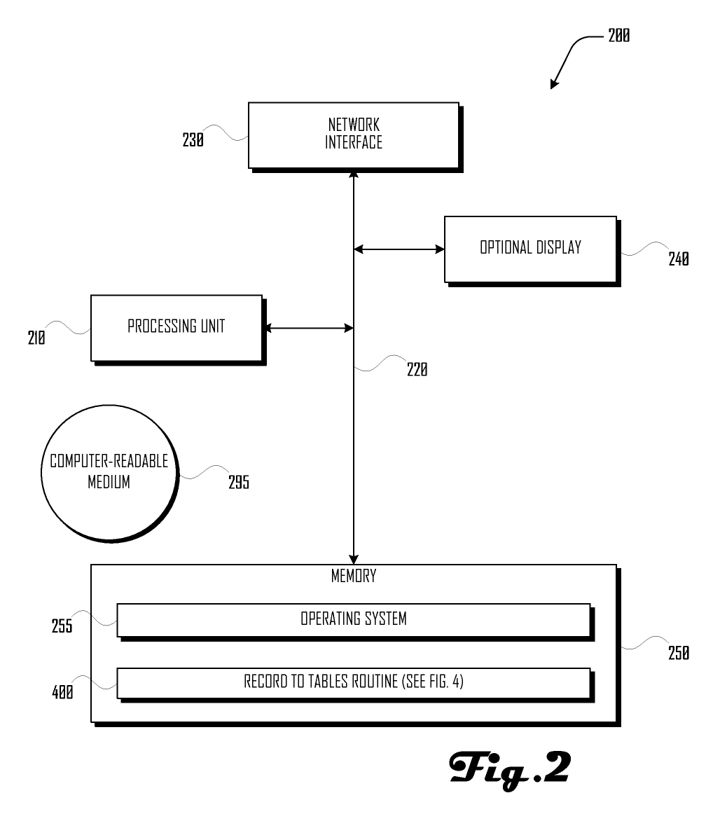

FIG. 2 illustrates several components of an exemplary ERP client device 200. In some embodiments, ERP client device 200 may include many more components than those shown in FIG. 2. However, it is not necessary that all of these generally conventional components be shown in order to disclose an illustrative embodiment. As shown in FIG. 2, the ERP client device 200 includes a network interface 230 for connecting to the network 150.

The ERP client device 200 also includes a processing unit 210, a memory 250, and an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for record to tables routine 400. In addition, the memory 250 also stores an operating system 255. These software components may be loaded from a non-transient, tangible computer readable storage medium 295 into memory 250 of the ERP client device 200 using a drive mechanism (not shown) associated with a non-transient, tangible computer readable storage medium 295, such as a floppy disc, tape, DVD/CD-ROM drive, memory card, or the like. In some embodiments, software components may also be loaded via the network interface 230, rather than via a computer readable storage medium 295.

Although an exemplary ERP client device 200 has been described that generally conforms to conventional general purpose computing devices, an ERP client device 200 may be any of a great number of devices capable of communicating with the network 150 and/or ERP Server 110, for example, a personal computer, a game console, a set-top box, a handheld computer, a cell phone, or the like.

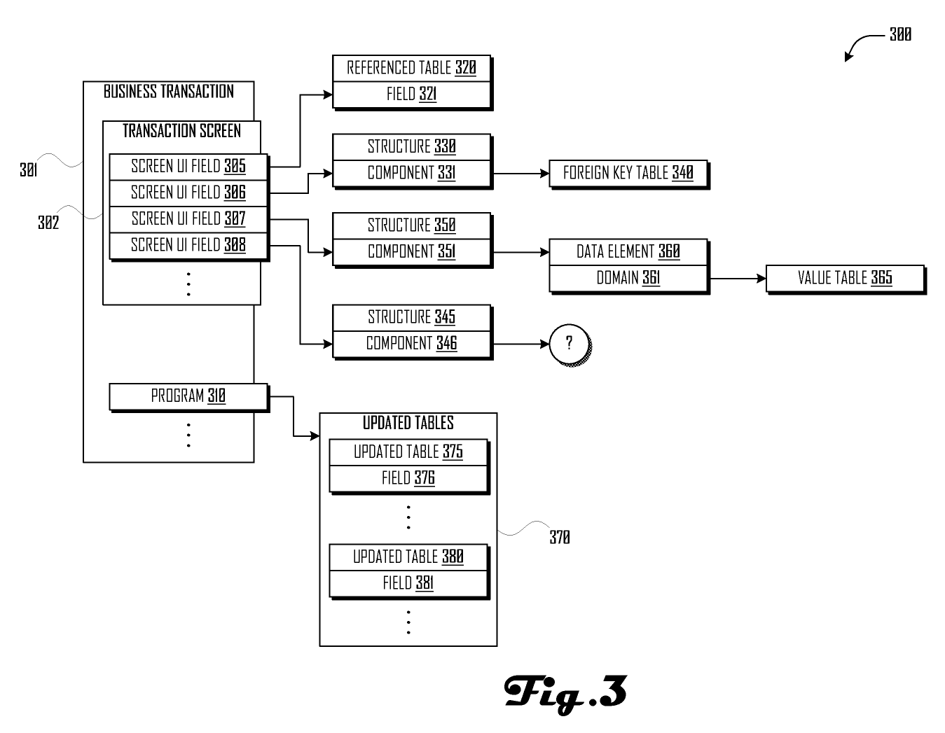

FIG. 3 illustrates a conceptual overview 300 of various data relationships in accordance with one embodiment. Business transaction 301 represents an ERP transaction defined and performed via at least one transaction screen 302, which typically includes several screen UI fields 305-307. Underlying the transaction screen 302 is at least one program 310, which may reside in the ERP database, and that includes logic for processing data entered via transaction screen 302 and updating appropriate database tables. In some cases, program 310 may be an Advanced Business Application Programming (“ABAP”) program.

Each screen UI field (e.g., 305-307) typically corresponds to a particular field in a persistent database table in the ERP database. However, as shown in conceptual overview, there may be zero or more layers of indirection between a screen UI field and a corresponding persistent database table.

For example, screen UI field 305 directly references field 321 of persistent table 320. Thus, a standard ERP dereferencing function (not shown), when called on field 305, returns an identifier to field 321. Thus, it can be determined that screen UI field 305 references source table 320. However, for many screen UI fields, one or more layers of indirection separate the UI field from a persistent ERP database table.

For example, an ERP dereferencing function, when called on field 306, returns an identifier not to a field of a table, but to a component of a non-persistent, intermediate “structure.” A structure is a template of some or all fields of one or more database tables, the structure fields being filled with data values at the time of program execution. Structures are temporary or non-persistent intermediates, typically located in RAM or other short-term memory, where data is stored while it is being processed by a program (e.g., program 310). Once the program has terminated, the structure is no longer accessible. Consequently, a structure that is referenced by a screen UI field cannot be subsequently queried, such as if the business user wished to create a subsequent report related to the business transaction.

However, according to methods as described further below, some embodiments may be able to peel back one or more layers of indirection, automatically determining that, for example, screen UI field 306 ultimately references source foreign key table 340 via component 331, and that screen UI field 307 ultimately references source value table 365 via domain 361 of data element 360 of component 351.

In some cases, such as screen UI field 308, a referenced component (e.g., component 346) may not lead to an identifiable source database table. In such cases, as described further below, a list of tables 370 updated by program 310 may be analyzed, which analysis may frequently suggest one or more source database tables that may be ultimately referenced by screen UI field 308.

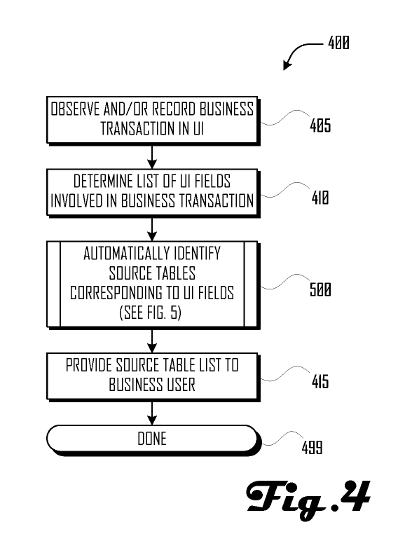

FIG. 4 illustrates a routine 400 for mapping screen UI fields associated with a business transaction to respectively corresponding source database tables, in accordance with one embodiment. In block 405, routine 400 observes and/or records a business transaction as performed by a business user via one or more UI screens.

Based on the recording and/or observation, in block 410, routine 400 determines a list of one or more screen UI fields that are involved in the business transaction. For example, in one embodiment, the list may include all screen UI fields of all UI screens of the business transaction.

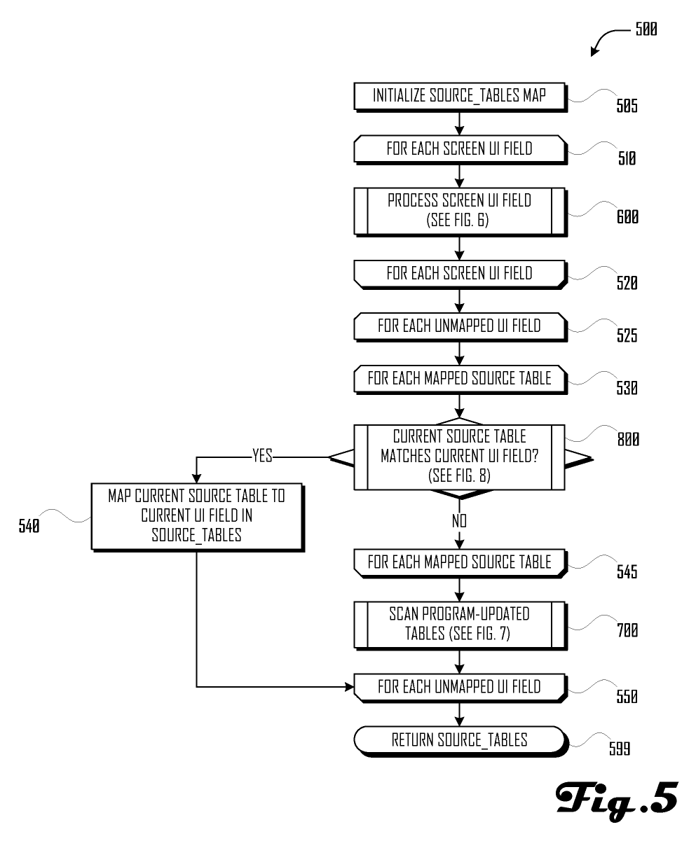

In subroutine block 500 (see FIG. 5, discussed below), routine 400 automatically identifies a list of persistent database tables that definitely or likely correspond to the one or more screen UI fields that are involved in the business transaction.

In block 415, routine 400 provides the list of source database tables to the business user, for use as the business user sees fit. Routine 400 ends in block 499.

FIG. 5 illustrates a subroutine 500 for automatically identifying a list of persistent database tables that correspond to a given list of one or more screen UI fields that are involved in a given business transaction, in accordance with one embodiment.

In block 505, subroutine 500 initializes a source_tables map. In various embodiments, the source_tables map may comprise, at various times, a list, array, hash, XML data, or a similar structure stored in transient or persistent memory, one or more database tables, or other like data structure. The source_tables “map” may further be capable of associating two pieces of data with one another. For example, in one embodiment, source_tables map may include a list (or array, or hash, or the like) of key-value pairs or similar associative structure. In other embodiments, source_tables map may include a pair of parallel lists (or arrays or the like), with associated entries being stored at related indices. In still other embodiments, any other suitable data structure may be employed.

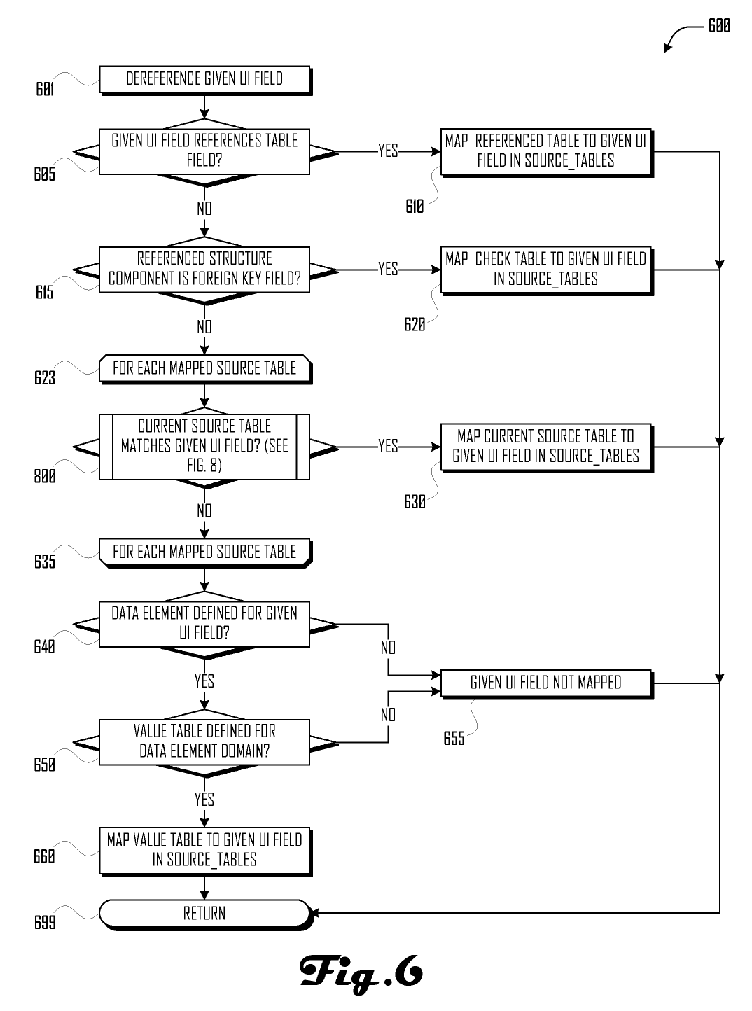

Beginning in opening loop block 510, subroutine 500 processes each of the given screen UI fields. In subroutine block 600 (see FIG. 6, discussed below), subroutine 500 processes the current screen UI field, after which the current screen UI field may or may not be successfully mapped to a persistent database table. In ending block 520, subroutine 500 iterates back to block 510 to process the next screen UI field (if any).

Once all screen UI fields have been processed by subroutine 500, some of the screen UI fields may remain unmapped. Beginning in opening loop block 525, subroutine 500 processes the unmapped screen UI fields. Beginning in opening loop block 530, subroutine 500 processes each persistent table that was identified and mapped to a screen UI field in subroutine block 600.

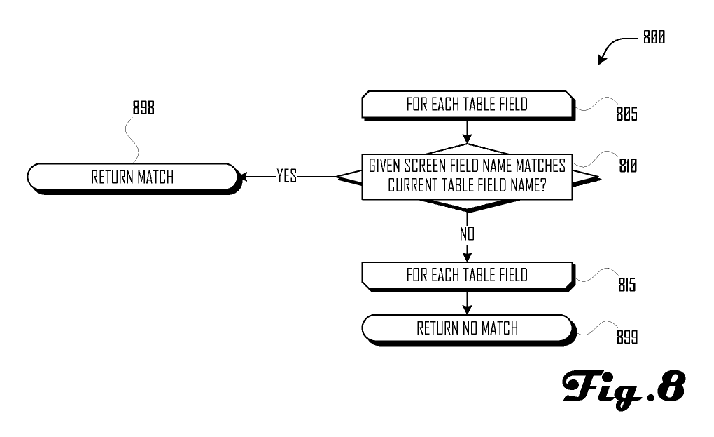

In subroutine decision block 800 (see FIG. 8, discussed below), subroutine 500 determines whether the current persistent table includes a field that is a likely match for the current unmapped screen UI field. If so, then in block 540, subroutine 500 maps the current persistent table to the current screen UI field in source_tables map. Subroutine 500 then skips to closing loop block 550 and iterates back to block 525 to process the next unmapped screen UI field (if any).

However, if subroutine 500 determines in subroutine decision block 800 that the current persistent table does not include a field that is a likely match for the current unmapped screen UI field, then in closing loop block 545, subroutine 500 iterates back to block 530 to process the next mapped persistent table (if any).

Once all mapped persistent tables have been processed, but no likely matches found, then in subroutine block 700, subroutine 500 updates the current unmapped screen UI fields according to an exhaustive scan of persistent tables updated by programs associated with the given business transaction.

In ending block 550, subroutine 500 iterates back to block 530 to process the next unmapped screen UI field (if any). Subroutine 500 ends in block 599, returning the source_tables map to the caller.

FIG. 6 illustrates a subroutine 600 for attempting to automatically identify a persistent database table for a given screen UI field, in accordance with one embodiment. In block 601, subroutine 600 uses a standard ERP dereferencing function to obtain an identifier to a field or component in a source database table (persistent) or a “structure” (transient, see discussion above in respect to FIG. 3).

In decision block 605, subroutine 600 determines whether the identifier obtained in block 601 identifies a field in a persistent table (as opposed to a component of a transient structure). If so, then in block 610, subroutine 600 maps the referenced table as the source table of the given screen UI field in source_tables map, and subroutine 600 ends in block 699.

Otherwise, if subroutine 600 determines in block 605 that the identifier identifies a component of a non-persistent, intermediate structure, then in decision block 615, subroutine 600 determines whether the identified structure component is a “foreign key field.” A foreign key links two database tables by assigning fields of the first table to the primary key fields of the second table. In some embodiments, the first table is called the foreign key table (dependent table) and the second table is called the check table (referenced table). Thus, in decision block 615, subroutine 600 determines whether the identified component is a “foreign key field” corresponding to a key field of an identifiable check table. If so, then in block 620, subroutine 600 maps the check table as the source table of the given screen UI field in source_tables map, and subroutine 600 ends in block 699.

Otherwise, if the identified structure component is not a foreign key field, then beginning in opening loop block 623, subroutine 600 processes each source table (if any) that has already been identified and mapped to a screen UI field in source_tables map during a previous instantiation of subroutine 600.

In subroutine decision block 800 (see FIG. 8, discussed below), subroutine 600 determines whether the current source table includes a field that is a likely match for the given screen UI field. If so, then in block 630, subroutine 600 maps the current source table to the given screen UI field in source_tables map, and subroutine 600 ends in block 699.

However, if subroutine 600 determines in subroutine decision block 800 that the current source table does not include a field that is a likely match for the given screen UI field, then in closing loop block 635, subroutine 600 iterates back to block 623 to process the next mapped source table (if any).

Once all mapped source tables have been processed, but no likely matches found, then in decision block 640, subroutine 600 determines whether a “data element” is defined for the given screen UI field. In some embodiments, a data element is an elementary type, which describes the type attributes (e.g., data type, field length, possibly the number of decimal places, and the like) and screen information (e.g., explanatory text, field help, and the like) about unstructured data objects such as table fields, structure components, and the like. Table fields and structure components that should have the same contents should refer to the same data element to ensure that the attributes of such fields remain consistent.

If no data element is defined for the given screen UI field, then in block 655, the given screen UI field is indicated to remain unmapped (e.g., by adding the given screen UI field to a list of unmapped fields, by simply not updating source_tables map, or by other means), and subroutine 600 ends in block 699.

On the other hand, if a data element is defined for the given screen UI field, then in decision block 650, subroutine 600 determines whether the data element type refers to a particular “domain,” and if so, whether a “value table” is defined for that domain.

A domain describes the technical attributes of a data object, such as the data type, the number of positions in a field, or the like. In many embodiments, a given domain defines a value range describing validation values for validating data objects referring to the domain. Different data objects of the same type can be combined in a domain. Data objects referring to such a domain are changed whenever the domain is changed, ensuring the consistency of such data objects.

In some cases, a domain can be defined such that all the fields referring to this domain should be checked against a set of valid values. A value table is a database table against which all data objects of a given domain are checked.

If, in decision block 650, subroutine 600 determines that the data element type refers to a domain and that a value table is defined for that domain, then in block 660, subroutine 600 maps the value table to the given screen UI field in source_tables map, and subroutine 600 ends in block 699.

Otherwise, in block 655, the given screen UI field is indicated to remain unmapped (e.g., by adding the given screen UI field to a list of unmapped fields, by simply not updating source_tables map, or by other means), and subroutine 600 ends in block 699.

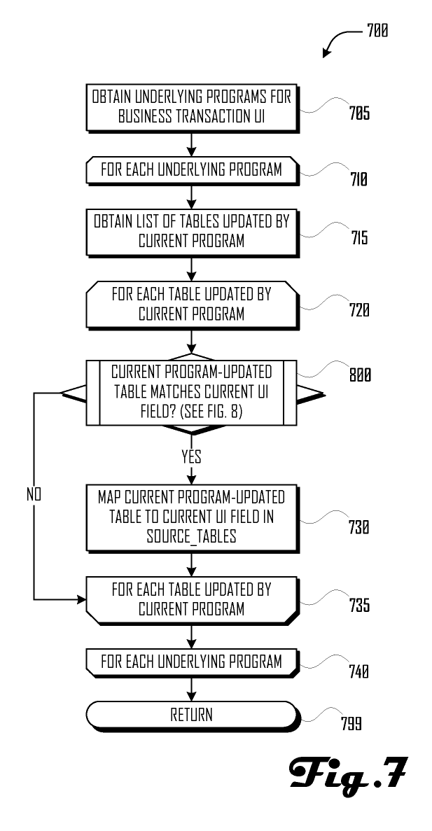

FIG. 7 illustrates a subroutine 700 for updating a given unmapped screen UI field according to an exhaustive scan of tables updated by programs associated with a given business transaction, in accordance with one embodiment.

In block 705, subroutine 700 obtains a list of one or more programs (see discussion above in regard to FIG. 3) that underlie the given business transaction. In some embodiments, this list may be cached from a previous instantiation of subroutine 700.

Beginning in opening loop block 710, subroutine 700 processes each underlying transaction program. In block 715, subroutine 700 obtains a list of persistent tables updated by the current transaction program. In some embodiments, subroutine 700 may call a standard ERP function to obtain a list of at least some of the tables updated by the current transaction program. In some embodiments, this list may be cached from a previous instantiation of subroutine 700.

Beginning in opening loop block 720, subroutine 700 processes each table of the list of at least some of the tables updated by the current transaction program.

In subroutine decision block 800 (see FIG. 8, discussed below), subroutine 700 determines whether the current program-updated table includes a field that is a likely match for the given unmapped screen UI field. If so, then in block 730, subroutine 700 maps the current program-updated table to the given screen UI field in source_tables map.

In closing loop block 735, subroutine 700 iterates back to block 720 to process the next table (if any) of the list of at least some of the tables updated by the current program. In closing loop block 740, subroutine 700 iterates back to block 710 to process the next underlying program (if any). Subroutine 700 ends in block 799.

FIG. 8 illustrates a subroutine 800 for determining whether a given table includes a field that is a likely match for a given screen UI field, in accordance with one embodiment.

Beginning in opening loop block 805, subroutine 800 processes each field of the given table. In decision block 810, subroutine 800 determines whether the name of the given screen UI field matches the name of the current field of the given table. If so, then the current field is at least potentially the source field for the given screen UI field, and subroutine 800 ends in block 898, returning an indication that the given table is a likely match to be the source table for the given screen UI field.

However, if the name of the given screen UI field does not match the name of the current field of the given table, then in closing loop block 815, subroutine 800 iterates back to block 805 to process the next field (if any) of the given table. Once all fields have been processed with no likely matches found, subroutine 800 ends in block 899, returning an indication that the given table is not a likely match to be the source table for the given screen UI field.

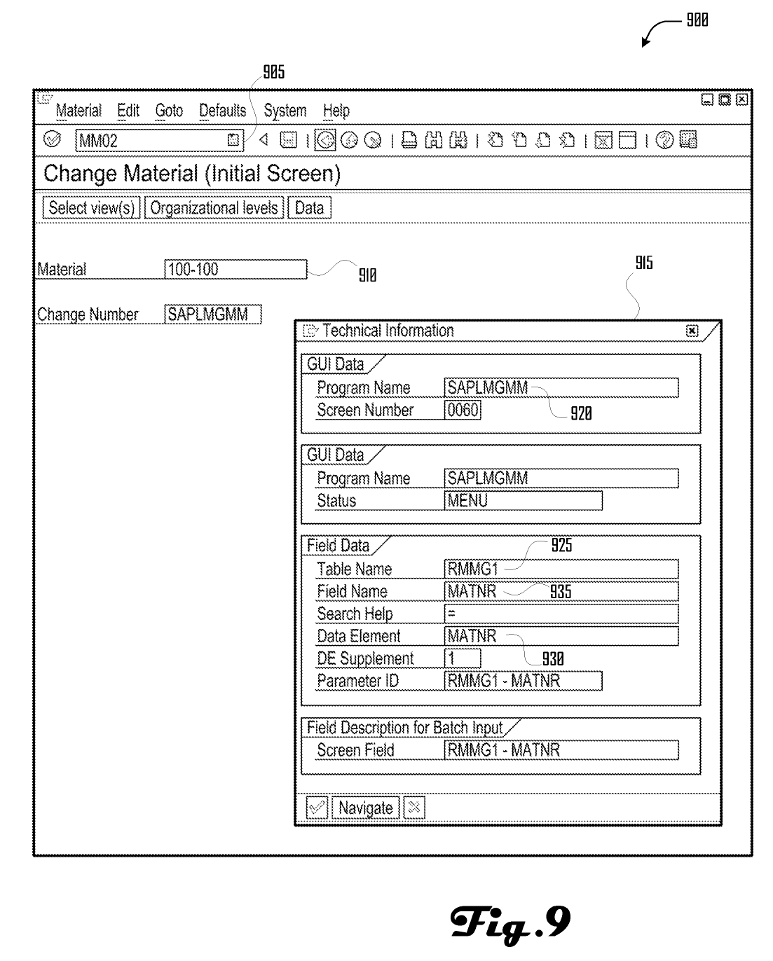

FIG. 9 illustrates an exemplary user interface 900 showing one screen associated with a “Change Material” business transaction. The business transaction is identified by a transaction code 905, and the screen includes a screen UI field 910. Also displayed is a UI 915 displaying various pieces of technical information associated with screen UI field 910 and/or business transaction 905, including a name 920 of an underlying program, a name 935 of screen UI field 910, and a data element 930 defined for screen UI field 910. UI 915 also includes a “Table Name” field that, in this case, displays an identifier 925 of a source structure (not actually a table) for screen UI field 910.

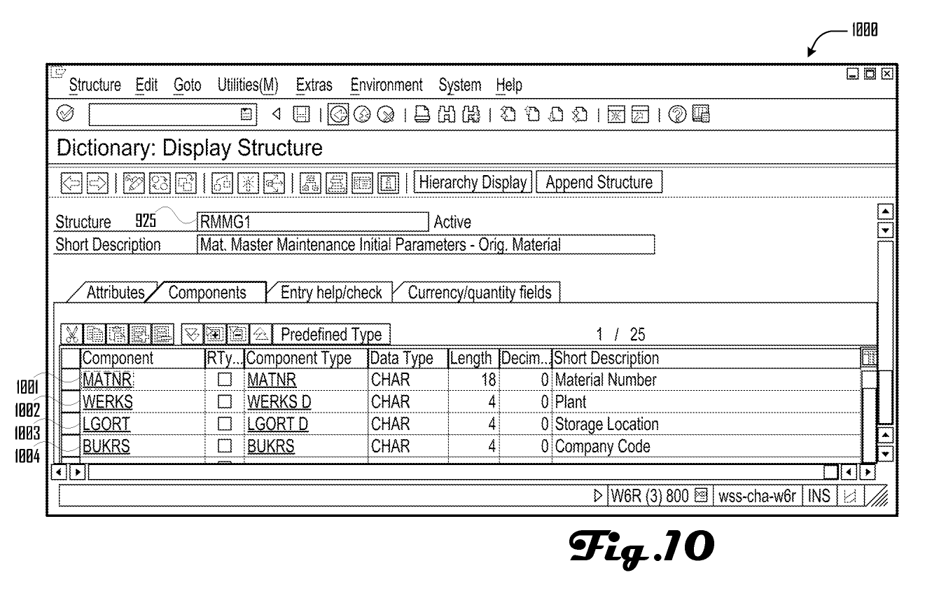

FIG. 10 illustrates an exemplary user interface 1000 showing information about the structure identified by identifier 925, including information about several constituent structure components 1001-1004.

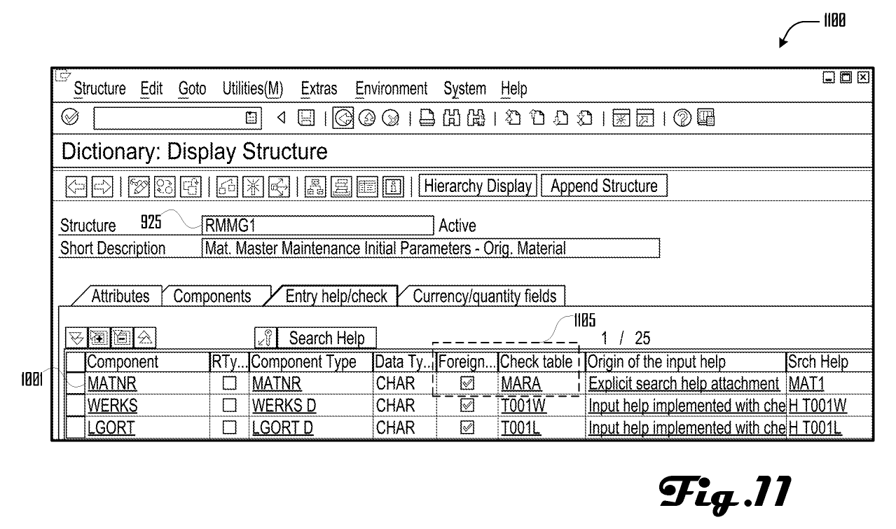

FIG. 11 illustrates an exemplary user interface 1100 showing information about the structure identified by identifier 925, including an indication 1105 that structure component 1001 is a foreign key field corresponding to a key field of a check table “MARA.”

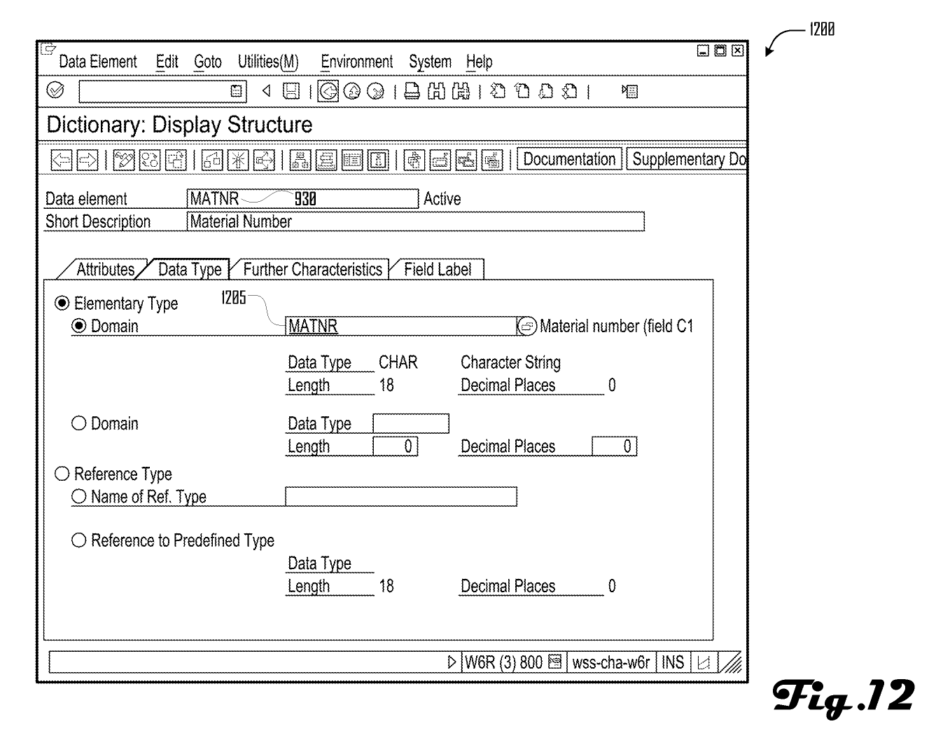

FIG. 12 illustrates an exemplary user interface 1200 showing information about data element 930, including an indication 1205 that data element 930 refers to domain 1205 (“MATNR”).

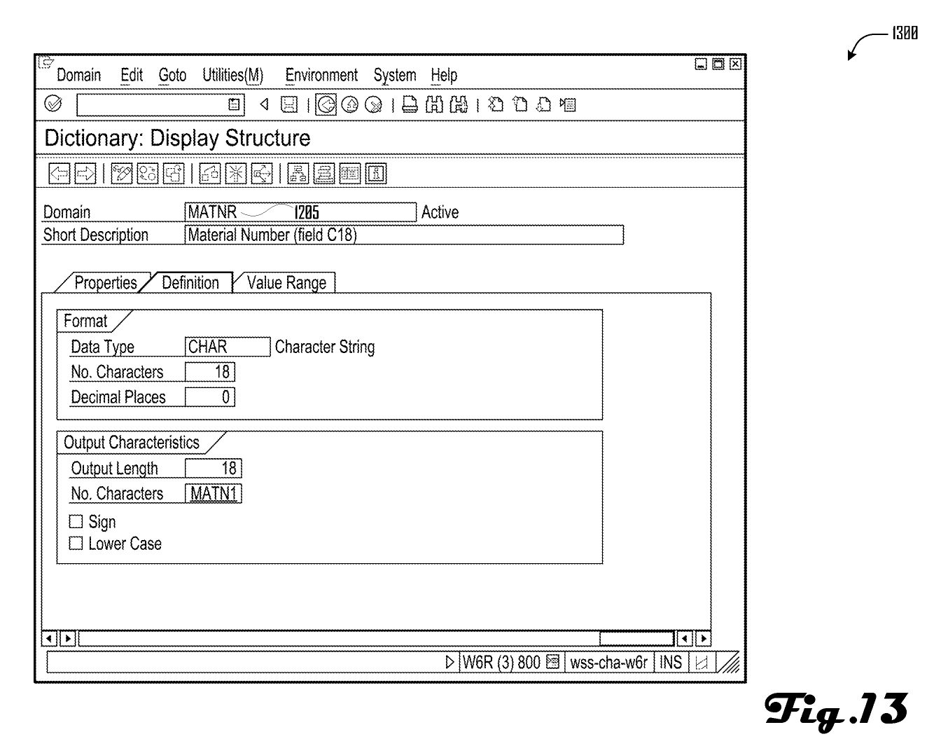

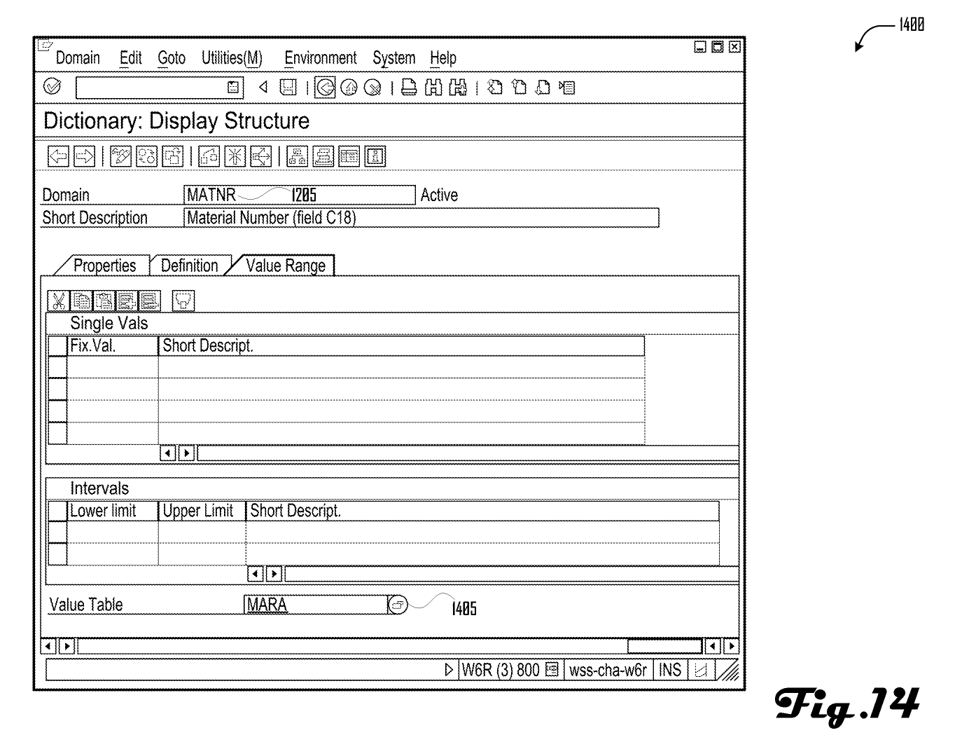

FIGS. 13 and 14 illustrate exemplary user interfaces 1300, 1400 showing information about domain 1205 (“MATNR”), including a definition of value table 1405 (“MARA”) for domain 1205.

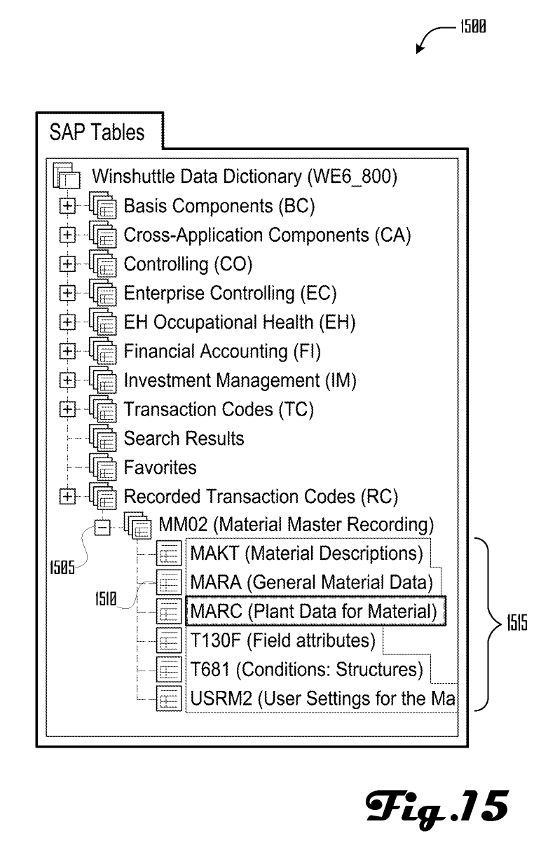

FIG. 15 illustrates an exemplary user interface 1500 identifying a group of persistent database tables 1515 that have been determined to be associated with screen UI fields of a recorded business transaction 1505, including persistent database table “MARA” 1510.

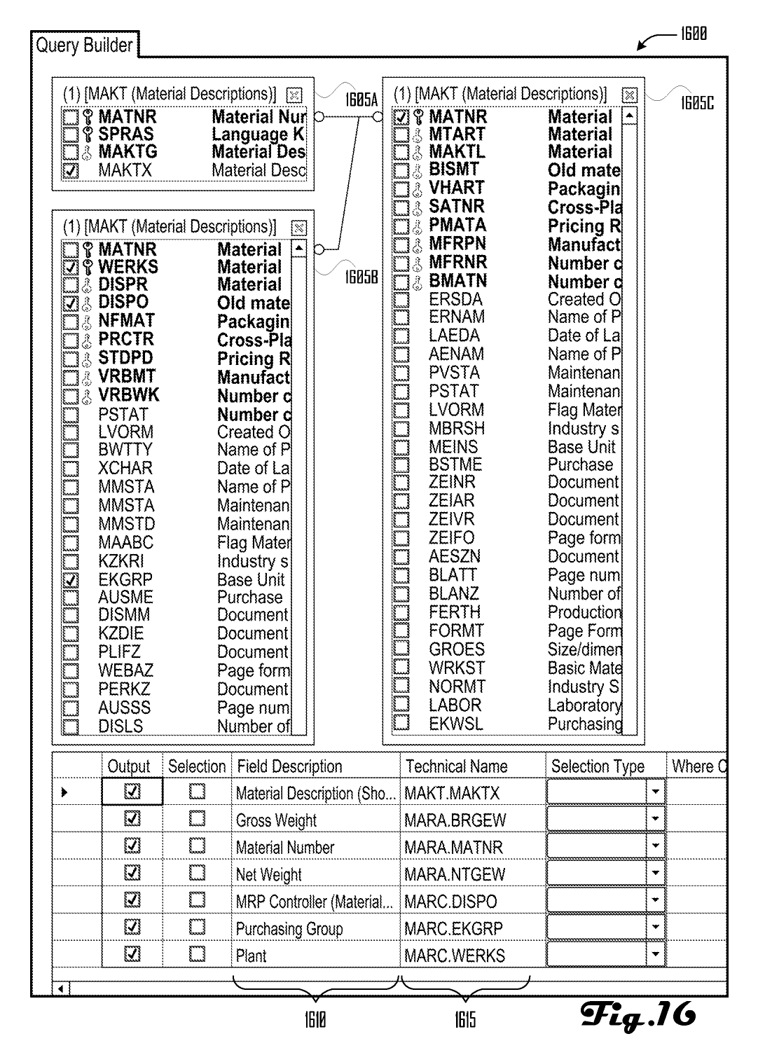

FIG. 16 illustrates an exemplary user interface 1600 such as a use might use to build a query related to a business transaction in accordance with one embodiment. User interface 1600 identifies a group of persistent database tables 1615A-C that have been determined to be associated with screen UI fields 1610 of a recorded business transaction. Screen UI fields 1610 are shown to be associated with particular fields of particular persistent database tables 1615 (e.g., field “MATNR” of persistent table “MARA”, notated as “MARA.MATNR”). Additionally, several persistent database tables 1605A-C are depicted along with their respective fields.

Although specific embodiments have been illustrated and described herein, it will be appreciated by those of ordinary skill in the art that a whole variety of alternate and/or equivalent implementations may be substituted for the specific embodiments shown and described without departing from the scope of the present invention. For example, although the description above refers to embodiments involving enterprise resource planning systems, other embodiments may be similarly used in other types of enterprise application systems in which a transaction between an enterprise client and an enterprise server may be recorded and mapped, as variously described above. For example, the systems and methods described herein may be used in connection with enterprise systems such as customer relationship management (“CRM”) systems, accounting systems, supply chain management systems, and the like. This application is intended to cover any adaptations or variations of the embodiments discussed herein.

What is claimed is:

1. A computer-implemented method for identifying, from among a multiplicity of persistent database tables of an Enterprise Resource Planning (“ERP”) system, one or more persistent database tables that are associated with a business transaction, the method comprising:
identifying, by the computer, a plurality of user interface (“UI”) fields for collecting and/or presenting data associated with the business transaction in a transaction UI;
dereferencing, by the computer, said plurality of UI fields to identify a plurality of transient components of one or more non-persistent, intermediate structures, said plurality of transient components respectively corresponding to said plurality of UI fields;
iteratively processing, by the computer, said pluralities of UI fields and transient components to identify a group comprising one or more persistent database tables that are each indirectly associated with one or more of said plurality of UI fields; and
providing, by the computer for display to a business user of the ERP system, a transaction tables UI identifying at least said group of persistent database tables and their respective indirect associations with some or all of said plurality of UI fields.

2. The method of claim 1, wherein given a transient component that is referenced by a given UI field, automatically processing said plurality of transient components comprises:
determining whether said given transient component references a primary key field of a determined one of the multiplicity of persistent database tables of the ERP system; and
when said given transient component is determined to reference said primary key field, identifying said determined persistent database table as being indirectly associated with said given UI field.

3. The method of claim 1, wherein given a UI field, automatically processing said plurality of transient components comprises:
determining whether said given UI field is associated with a set of validation values for validating data objects of a certain type, said set of validation values being defined in a determined one of the multiplicity of persistent database tables of the ERP system data; and
when said given UI field is determined to be associated with said set of validation values, identifying said determined persistent database table as being indirectly associated with said given UI field.

4. The method of claim 1, wherein given a transient component that is referenced by a given UI field, and given a persistent database table that has been previously identified as being indirectly associated with a previously processed UI field, automatically processing said plurality of transient components comprises:
identifying a plurality of table fields of said previously identified persistent database table;
determining whether a UI field name of said given UI field matches a table field name of any one of said plurality of table fields; and
when said UI field name is determined to match said table field name, identifying said given persistent database table as being indirectly associated with said given UI field.

5. The method of claim 1, wherein given a UI field, automatically processing said plurality of transient components comprises:
identifying a transaction program comprising logic for processing said data associated with the business transaction;
identifying a program-updated persistent database table that is updated by said transaction program;
identifying a plurality of table fields of said program-updated persistent database table;
determining whether a UI field name of said given UI field matches a table field name of any one of said plurality of table fields; and
when said UI field name is determined to match said table field name, identifying said program-updated persistent database table as being indirectly associated with said given UI field.

6. The method of claim 1, further comprising:
identifying an additional UI field for collecting and/or presenting data associated with the business transaction in said transaction UI;
dereferencing said additional UI field to identify a directly-associated persistent database table; and
identifying, via said transaction tables UI, said directly-associated persistent database table as being directly associated with said additional UI field.

7. A non-transient computer-readable storage medium having stored thereon instructions that, when executed by a processor, configure the processor to perform a method for identifying, from among a multiplicity of persistent database tables of an Enterprise Resource Planning (“ERP”) system, one or more persistent database tables that are associated with a business transaction, the method comprising:
identifying a plurality of user interface (“UI”) fields for collecting and/or presenting data associated with the business transaction in a transaction UI;
dereferencing said plurality of UI fields to identify a plurality of transient components of one or more non-persistent, intermediate structures, said plurality of transient components respectively corresponding to said plurality of UI fields;
iteratively processing said pluralities of UI fields and transient components to identify a group comprising one or more persistent database tables that are each indirectly associated with one or more of said plurality of UI fields; and
providing, for display to a business user of the ERP system, a transaction tables UI identifying at least said group of persistent database tables and their respective indirect associations with some or all of said plurality of UI fields.

8. The storage medium of claim 7, wherein given a transient component that is referenced by a given UI field, automatically processing said plurality of transient components comprises:
determining whether said given transient component references a primary key field of a determined one of the multiplicity of persistent database tables of the ERP system; and
when said given transient component is determined to reference said primary key field, identifying said determined persistent database table as being indirectly associated with said given UI field.

9. The storage medium of claim 7, wherein given a UI field, automatically processing said plurality of transient components comprises:
determining whether said given UI field is associated with a set of validation values for validating data objects of a certain type, said set of validation values being defined in a determined one of the multiplicity of persistent database tables of the ERP system data; and
when said given UI field is determined to be associated with said set of validation values, identifying said determined persistent database table as being indirectly associated with said given UI field.

10. The storage medium of claim 7, wherein given a transient component that is referenced by a given UI field, and given a persistent database table that has been previously identified as being indirectly associated with a previously processed UI field, automatically processing said plurality of transient components comprises:
identifying a plurality of table fields of said previously identified persistent database table;
determining whether a UI field name of said given UI field matches a table field name of any one of said plurality of table fields; and
when said UI field name is determined to match said table field name, identifying said given persistent database table as being indirectly associated with said given UI field.

11. The storage medium of claim 7, wherein given a UI field, automatically processing said plurality of transient components comprises:
identifying a transaction program comprising logic for processing said data associated with the business transaction;
identifying a program-updated persistent database table that is updated by said transaction program;
identifying a plurality of table fields of said program-updated persistent database table;
determining whether a UI field name of said given UI field matches a table field name of any one of said plurality of table fields; and
when said UI field name is determined to match said table field name, identifying said program-updated persistent database table as being indirectly associated with said given UI field.

12. The storage medium of claim 7, further comprising:
identifying an additional UI field for collecting and/or presenting data associated with the business transaction in said transaction UI;
dereferencing said additional UI field to identify a directly-associated persistent database table; and
identifying, via said transaction tables UI, said directly-associated persistent database table as being directly associated with said additional UI field.

13. A computing apparatus comprising a processor and memory storing instructions that, when executed by the processor, configure the apparatus to perform a method for identifying, from among a multiplicity of persistent database tables of an Enterprise Resource Planning (“ERP”) system, one or more persistent database tables that are associated with a business transaction, the method comprising:
identifying a plurality of user interface (“UI”) fields for collecting and/or presenting data associated with the business transaction in a transaction UI;
dereferencing said plurality of UI fields to identify a plurality of transient components of one or more non-persistent, intermediate structures, said plurality of transient components respectively corresponding to said plurality of UI fields;
iteratively processing said pluralities of UI fields and transient components to identify a group comprising one or more persistent database tables that are each indirectly associated with one or more of said plurality of UI fields; and
providing, for display to a business user of the ERP system, a transaction tables UI identifying at least said group of persistent database tables and their respective indirect associations with some or all of said plurality of UI fields.

14. The computing apparatus of claim 13, wherein given a transient component that is referenced by a given UI field, automatically processing said plurality of transient components comprises:
determining whether said given transient component references a primary key field of a determined one of the multiplicity of persistent database tables of the ERP system; and
when said given transient component is determined to reference said primary key field, identifying said determined persistent database table as being indirectly associated with said given UI field.

15. The computing apparatus of claim 13, wherein given a UI field, automatically processing said plurality of transient components comprises:
determining whether said given UI field is associated with a set of validation values for validating data objects of a certain type, said set of validation values being defined in a determined one of the multiplicity of persistent database tables of the ERP system data; and
when said given UI field is determined to be associated with said set of validation values, identifying said determined persistent database table as being indirectly associated with said given UI field.

16. The computing apparatus of claim 13, wherein given a transient component that is referenced by a given UI field, and given a persistent database table that has been previously identified as being indirectly associated with a previously processed UI field, automatically processing said plurality of transient components comprises:
identifying a plurality of table fields of said previously identified persistent database table;
determining whether a UI field name of said given UI field matches a table field name of any one of said plurality of table fields; and
when said UI field name is determined to match said table field name, identifying said given persistent database table as being indirectly associated with said given UI field.

17. The computing apparatus of claim 13, wherein given a UI field, automatically processing said plurality of transient components comprises:
identifying a transaction program comprising logic for processing said data associated with the business transaction;
identifying a program-updated persistent database table that is updated by said transaction program;
identifying a plurality of table fields of said program-updated persistent database table;
determining whether a UI field name of said given UI field matches a table field name of any one of said plurality of table fields; and
when said UI field name is determined to match said table field name, identifying said program-updated persistent database table as being indirectly associated with said given UI field.

18. The computing apparatus of claim 13, further comprising:
identifying an additional UI field for collecting and/or presenting data associated with the business transaction in said transaction UI;
dereferencing said additional UI field to identify a directly-associated persistent database table; and
identifying, via said transaction tables UI, said directly-associated persistent database table as being directly associated with said additional UI field.
